(19) United States
(12) Patent Application Publication
(10) Pub. No.: US 2021/0204362 A1
(43) Pub. Date: Jul. 1, 2021

(54) Information Communication System

(71) Applicants: Allan Aitchison, Melbourne (AU); Doug Mackie, Melbourne (AU)

(72) Inventors: Allan Aitchison, Melbourne (AU); Doug Mackie, Melbourne (AU)

(21) Appl. No.: 17/258,140

(22) PCT Filed: Jul. 8, 2019
(86) PCT No.: PCT/AU2019/000081

§ 371 Date: Jan. 5, 2021

(30) Foreign Application Priority Data
Jul. 6, 2019 (AU) 2018902466

(51) Int. Cl. H04W 88/08; H04W 4/021; G06F 8/65

(52) U.S. Cl. CPC H04W 88/08; H04L 67/02; G06F 8/65; H04W 4/022

(57) ABSTRACT

There is disclosed a system for providing off-network electronic communication to a localised audience comprising: a base unit housing a computer system having an updateable web server and a wi-fi transmitter/receiver for providing wireless access to the updateable web server for the localised audience; a connector provided in said housing for providing controlled access to said updateable web server by an authorised content provider to facilitate updating of said updateable web server with information; wherein the wi-fi transmitter is accessible by one or more electronic devices associated with the localised audience such that the information contained in the web server can be reviewed by a conventional web browser of the electronic device in the absence of a remote network connection.

### RELATED APPLICATIONS

The present invention claims priority from Australian provisional patent application No. 2018902466 filed 6 Jul. 2018, the entire contents of which are incorporated herein by reference.

### FIELD OF INVENTION

The present invention relates generally to a system for capturing and making available information relevant to a locality, and in particular, to an off-network information communication system capable of receiving and storing data for download to a user via a user's personal electronic device.

### BACKGROUND OF THE INVENTION

Due to the popularity of devices such as smart phones and similar personal electronic devices, it is common for individuals to be constantly connected to a telecommunication network to access information via the internet and make calls. A variety of different types of networks are available to ensure that individuals are in constant connection as they travel or commute around cities or towns, and most smart phones or devices are equipped with a basic web browser to facilitate internet connectivity and to search the internet.

Thus, whilst individuals may constantly have the technology at their disposal to connect to the internet and the like through their smart phone or device, there are instances where there may be an absence of a network, due to the individual being outside of network coverage or through network failure, to facilitate any useful connection to the internet. In such instances, the smart phone or personal electronic device is largely unusable.

In remote areas, where network access is not available or reliable, individuals such as tourists or the like, are often only able to obtain information about a source through radio contact or through conventional notice board postings. Often, tourists visiting a region where network coverage is poor or non-existent, fail to fully appreciate the features of the region and any special events or information of note unless they have collected this information before travel. In this regard, they often have limited information at their disposal relating to the region and businesses or services available to them, other than what may be posted on a community information board and even then, that information may be incorrect or out of date.

Similarly, for public areas such as airports and cities, should the network become unavailable through system error or disaster, there is little ability to download information, such as safety points, flight times, and any other relevant information that may be required. Typically, such situations are met with mass confusion and chaos which can cause panic and endanger lives if not managed correctly.

Thus, there is a need to provide an information communication system that is capable of functioning in the absence of a network and which is able to communicate with a user's smart phone or personal electronic device to download information to be used by the user.

The above references to and descriptions of prior proposals or products are not intended to be, and are not to be construed as, statements or admissions of common general knowledge in the art. In particular, the above prior art discussion does not relate to what is commonly or well known by the person skilled in the art, but assists in the understanding of the inventive step of the present invention of which the identification of pertinent prior art proposals is but one part.

### STATEMENT OF INVENTION

The invention according to one or more aspects is as defined in the independent claims. Some optional and/or preferred features of the invention are defined in the dependent claims.

Accordingly, in one aspect of the invention there is provided a system for providing off-network electronic communication to a localised audience comprising:
a base unit housing a computer system having an updateable web server and a wi-fi transmitter/receiver for providing wireless access to the updateable web server for the localised audience;
a connector provided in said housing for providing controlled access to said updateable web server by an authorised content provider to facilitate updating of said updateable web server with information;
wherein the wi-fi transmitter is accessible by one or more electronic devices associated with the localised audience such that the information contained in the web server can be reviewed by a conventional web browser of the electronic device in the absence of a remote network connection.

The base unit may further comprise a power source for providing power to said computer system of the base unit. The power source may be a battery chargeable by a solar panel mounted with respect to the base unit.

The connector may be a USB port and the access to the updateable web server may be controlled by a computer controller of the computer system. The computer controller of the computer system may only facilitate access to said updateable web server by a paired USB stick provided by an authorised content provider.

Upon the computer controller acknowledging that the USB stick is paired with the computer controller, the information contained on said. USB stick may automatically update the updateable web server.

The one or more electronic devices may comprises a personal electronic device. The personal electronic device may be a smart phone or tablet.

In another aspect of the invention, there is provided a method of providing off- network electronic communication to a localised audience comprising:
constructing a base unit for access by the localised audience;
activating the base unit to be accessible to the localized audience;
facilitating information exchange between the base unit and the localized audience; and
controlling the update of information contained by the base unit to maintain currency and integrity of the information.

In one embodiment, the step of constructing the base unit comprises forming a site for the base unit to be constructed, the site comprising a foundation for supporting the base unit thereon. The base unit may comprise a housing for housing a server having one or more microprocessors and memory operably connected to one or more central processing units. The housing may be mounted upon the foundation.

The step of activating the base unit to be accessible to the localized audience may comprise connecting the base unit to one or more solar panels for supplying power to the server.

The step of facilitating information exchange between the base unit and the localized audience may comprise enabling localised individuals to access the base unit via their existing web browser. The localised audience may be enabled to browse and/or download a variety of information such as maps, photos, videos, pdf files, text files and the like using their existing web browser on their smart phone or tablet.

### BRIEF DESCRIPTION OF THE DRAWINGS

The invention may be better understood from the following non-limiting description of preferred embodiments, in which:

FIG. 1 is a system diagram of an information communication system in operation to disseminate information to local users;

FIG. 2 is a system diagram showing how content is uploaded to the information communication system of the present invention in a first step;

FIG. 3 is a system diagram showing how content is uploaded to the information communication system of the present invention in a second and final step; and

FIG. 4 is a flow chart depicting a method of providing off-network communications in accordance with an embodiment of the present invention.

### DETAILED DESCRIPTION OF THE DRAWINGS

Preferred features of the present invention will now be described with particular reference to the accompanying drawings. However, it is to be understood that the features illustrated in and described with reference to the drawings are not to be construed as limiting on the scope of the invention.

The system of the present invention will be described below in relation to its application for use in a remote setting such as a tourist location or camping site which is not serviced by a telecommunication network. Such a system may provide visitors to the remote site with a variety of authorised information that is regularly updated to assist the visitor in understanding their environment and obtaining as much information about the environment as they require, such as location and types of services, contact information, emergency services, road conditions and the like. However, it will be appreciated that the present invention may equally be employed in a variety of sites where information is required by people visiting the site, such as airports, cities and the like, such that information can be transmitted to the users even in the event of a network failure.

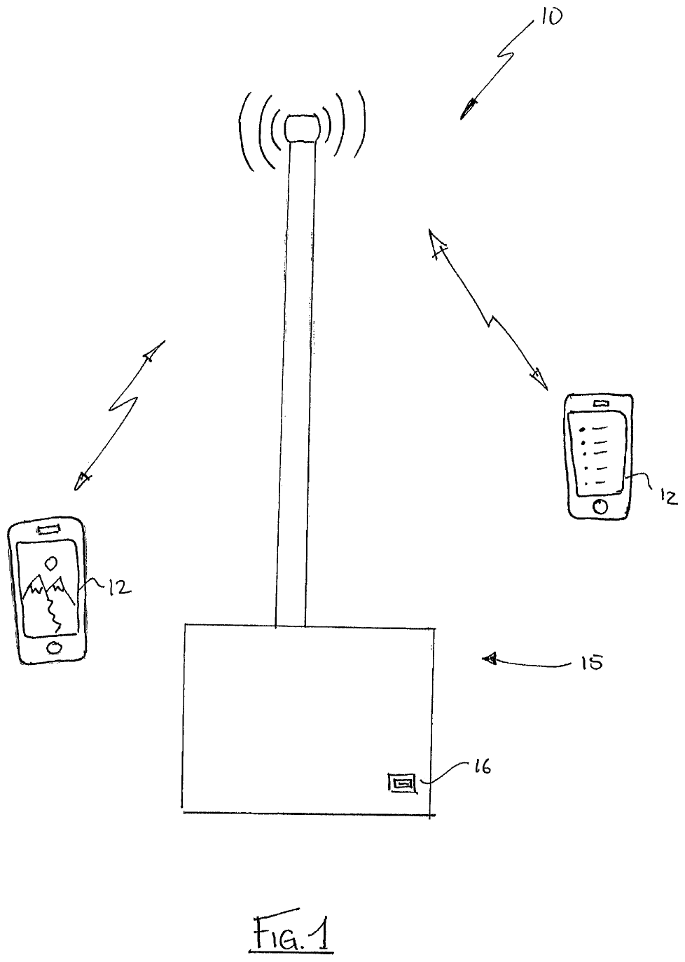

Referring to FIG. 1, an embodiment of a system 10 in accordance with the present invention is depicted. The system 10 generally comprises a base unit 15 in the form of an enclosed box which houses a server or similar computer system. The server is typically allocated with one or more central processing units or CPUs that includes one or more microprocessors and memory operably connected to the CPU. The memory can include any combination of random access memory (RAM), a storage medium such as a magnetic hard disk drive(s) and the like. The CPU may be configured to function in combination with a Wi-Fi transmitter that is capable of facilitating wireless electronic connection between a personal electronic device or smart phone 12 carried by a user or visitor to the base unit 15. Other types of local networks such as an intranet, an extranet, a virtual private network (VPN) and non-TCP/IP based networks are also envisaged. The base unit 15 may be powered by connection to a mains power line or, in the absence of such a power source, the base unit 15 may be self-powered and equipped with a solar panel and battery kit to ensure that power is constantly available to the base unit as required.

Due to the nature of use of the base unit, the computer system is generally housed within a robust and weatherproof housing that can be positioned anywhere as required, including upon peaks or lookouts, mountain trails, camping grounds, national parks, gardens and the like. Alternatively, such devices can be employed as part of a redundancy strategy around cities and airports to support councils and urban groups to provide a means for transmitting information to the public in the event of a remote network(s) failure. In this regard, the base unit 15 may be configured such that the CPU and associated transmitter is able to communicate with a remote network, such as the internet or a dedicated mobile or cellular network in combination with the internet, such as a GSM, CDMA or WCDMA network.

The base unit 15 may be installed in any location and generally comprises a foundation, in the form of modular block system, upon which the structure is installed. The foundation is capable of supporting a pole or structure upon which a solar panel unit can be installed for collecting power to operate the system off the grid. The solar panel unit may comprise a 18V/80 W high efficiency monocrystal panel 12V/10 to 30 W High Lumens, which is capable of supplying over 36 hours of power. The computer system may be installed within an appropriate box or cabinet that provides protection to the various electrical components and an external fence may be installed about the periphery of the foundation to provide a degree of security to the components of the system.

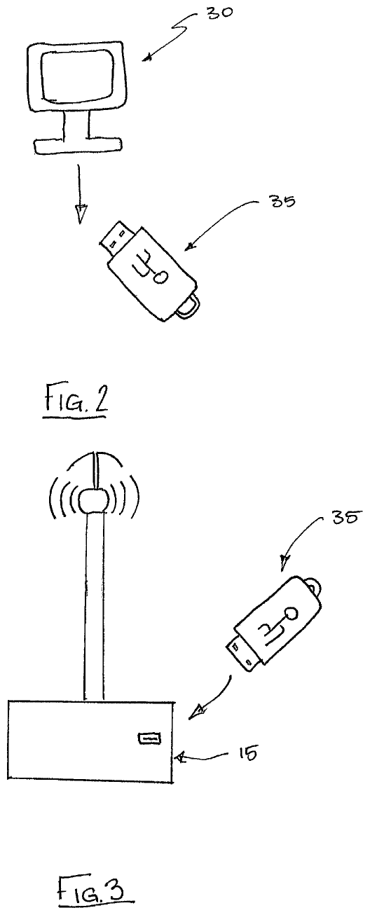

The computer system of the base unit 15 may be simply updated by an authorised individual visiting an appropriate update site configured with the appropriate software program to generate and upload new content to the CPU of the base unit 15 through a direct or indirect connection. A preferred manner for achieving this is described in relation to FIGS. 2 and 3.

FIG. 2 depicts the manner in which content may be created for uploading to the base unit 15. In one embodiment, the content can be created off-line or remotely by an authorised content provider. To become an authorised content provider, the user must register with the owner of the base unit 15, which may typically be a tourist bureau or council responsible for the management of the site. Once registered, the individual will become an authorised content provider for that base unit 15 and will be provided with a personal profile in a remotely hosted server held by the owner of the base unit 15. The authorised content provider is then able to log-in to a remotely web-site hosted by the owner of the base unit via their personal computer 30, or similar device, to create the content. This will provide them to access to the necessary software required to generate compatible material for display and dissemination by the base unit.

To authorise the new content created by the authorised content provider, the authorised content provider is able to upload the new content to the owner of the base unit's website. This new content may include images, videos as well as written content for review. In one embodiment of the invention, an overseer associated with the owner of the base unit 15 may review the content provided by the authorised content provider for approval. Upon approval the authorised content provider can then save the authorised content as an encrypted formatted file to a dedicated USB stick 35, or similar data memory device, provided by the owner of the base unit 15. The dedicated USB stick 35 is preferably paired to a dedicated base unit 15 to ensure that the only the content prepared for the dedicated base unit 15 can only be uploaded for dissemination from the specific base unit 15.

Referring to FIG. 3, the authorised content provider is then able to upload content to the paired base unit by physically attending or visiting the base unit 15 and inserting the dedicated USB stick into a provided socket 16 provided in the housing of the base unit 15. The encrypted formatted files present on the USB stick 35 are automatically uploaded by the CPU of the base unit 15 and the CPU and associated software of the base unit 15 then processes the files to build associated web pages and videos for storage in a web server stored and maintained within the base unit 15. Each time the authorised content provider inserts their USB stick into the base unit 15, the base unit will determine whether it is paired to communicate with the USB stick 35 and if so, any new material will be automatically detected and will add to or replace previous content provided by the authorised content provider, in accordance with the encrypted formatted file structure. As such, an internally stored web server will be built and maintained by the authorised content provider over time.

It will be appreciated that there may be multiple authorised content providers that each have a dedicated USB stick 35 paired to a particular base unit 15 such that multiple individuals may be responsible for updating specific data components of the internally stored web server for a particular base unit 15. Alternatively, multiple authorised content providers may be capable of submitting information via a website hosted by the owner of the base unit 15 with only the owner of the base unit 15 being responsible for uploading the data directly into the base unit 15.

Referring to FIG. 1, it will be appreciated that, when uploaded with data, the base unit 15 functions as a locally hosted webserver that is capable of being accessed by visitors to the base unit 15 through their smart phones or personal electronic devices in a conventional Wi-Fi manner. In this regard, any visitors 12 in proximity to the base unit 15 merely have to enable Wi-Fi connectivity on their smart phones 12 and select the SSID associated with the base unit 15 and use the existing web browsers present on their smart phones 12 to navigate the base unit's 15 web site.

Typically, the base unit 15 website will consist of a menu page with multiple sections that are able to be customised to contain information of any subject. Text, videos and images can be used to display information as necessary with all formats being compatible with existing web browsers provided on smart phones and other devices.

The encryption of the USB sticks 35 ensures a level of security of the information stored in the base unit website and provides a deterrent to hackers and the like.

It will be appreciated that as the base unit 15 does not require Internet connection, there are no ongoing costs for the owner of the base unit 15 each time a user accesses the base unit website. In this regard, each time a user connects to the base unit website and downloads files from the base unit, all downloads are from the local access point web server stored in the base unit and not from a network hosted site on the world wide web, thus resulting in free and instant access to a dedicated website specific to the user's needs.

With the system of the present invention, there is no requirement for users to purchase and/or download a specific software application to access the base unit website, nor is there any requirement for them to have an active network connection. This is particularly important in remote sites where network availability is poor or non-existent. In the present system, users are able to freely and immediately access content which is displayed directly to the user's personal electronic device or smart phone which is relative and specific to the region/are that the base unit is located.

It will be appreciated that in an alternative embodiment of the present invention, the owner of the base unit 15 and/or authorised content providers may, in the case of the presence of a permanent or temporary network, download content directly from their website to the base unit 15, as will be appreciated by those skilled in the art.

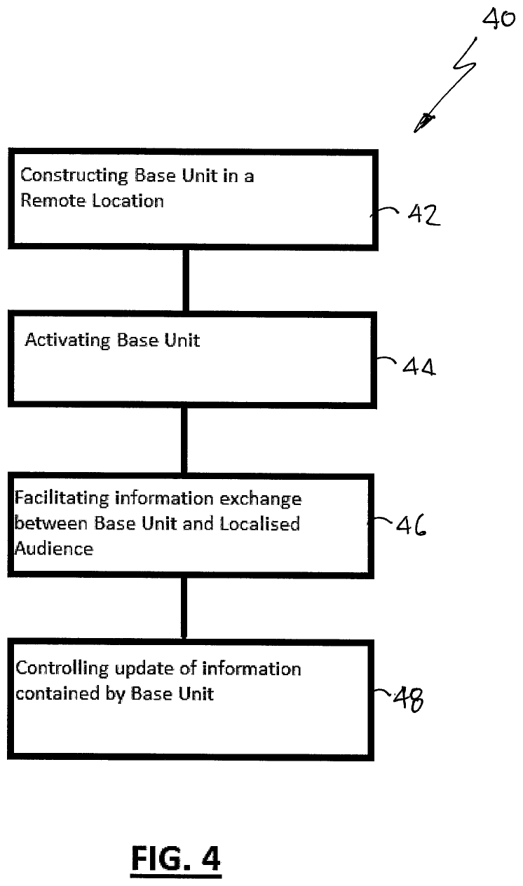

A method 40 of providing an off-network electronic communication system in a remote location is depicted in FIG. 4.

The method 40 comprises a first step 42 of constructing a base unit at the remote location. Depending upon the location, this step may comprise clearing an area for installing the base unit in an open and accessible location. In some terrain, this step may involve forming a foundation made from preformed bricks upon which the base unit is to be installed. A fence may be constructed around the base unit to protect it from animal infestation or damage due to vandals and the like.

The second step 44 comprises activating the base unit to enable visitors and other users to access information stored within the memory thereof. Power for the base unit may be supplied from one or more solar panels or the like mounted with respect to the base unit so as to provide sufficient power to drive the computer system of the base unit, especially where the base unit is remote from mains power.

The third step 46 of the method 40 comprises facilitating access of localised individuals to the base unit. Localised individuals in the immediate presence of the base unit are able to browse and/or download a variety of information such as maps, photos, videos, pdf files, text files and the like using their existing web browser on their smart phone or tablet.

In step 48, the information contained in the base unit for browsing by the localised audience on their existing smart phone or tablet can be updated as required by an authorised content provider. This can be achieved in the manner described above in relation to FIGS. 2 and 3 to ensure that the information accessed by the localised audience is not only up to date but also authorised from a reliable and registered source.

Such a method 40 enables anyone with a smart phone or similar electronic device with Wi-Fi capability and a modern web browser to connect to the base unit and view customised information in a free environment that is not reliant on remote network access. Such information will be relevant and trusted to assist a localised audience in a remote location to obtain information to assist them in maximising their experience.

It will be appreciated that the base unit of the present invention is able to supplement traditional signage to provide tourists and visitors direct access to content and information at the location where it is most needed. Depending upon the Wi-Fi connection, up to 200 users can be connected to a single base unit 15 at any one time. However, in some instances this can be increased, especially in urban regions.

In the case of cities and high population venues, the system of the present invention is also able to function in the event of a network failure to provide vital emergency, evacuation or recovery information which may be very helpful for large or complex sites where maps and the like are able to be viewed by users through their smart phones for guidance. Further to this, facilitating employee's with access to vital recovery information (including but not limited to how to get a network back up and operational) can save vital time in accessing written recovery plans for many businesses.

It will be appreciated that the system of the present invention enables hosts or owners of a base unit the ability to convey useful information to visitors, such as tourists using their own smart phone, even in the absence of network coverage. This is able to be done through a dedicated, stand-alone device that is self- powered to provide a free to use local network with instant access.

Throughout the specification and claims the word “comprise” and its derivatives are intended to have an inclusive rather than exclusive meaning unless the contrary is expressly stated or the context requires otherwise. That is, the word “comprise” and its derivatives will be taken to indicate the inclusion of not only the listed components, steps or features that it directly references, but also other components, steps or features not specifically listed, unless the contrary is expressly stated or the context requires otherwise.

It will be appreciated by those skilled in the art that many modifications and variations may be made to the methods of the invention described herein without departing from the spirit and scope of the invention.

The claims defining the invention are as follows:

1. A system for providing off-network electronic communication to a localised audience comprising:
a base unit housing a computer system having an updateable web server and a wi-fi transmitter/receiver for providing wireless access to the updateable web server for the localised audience;
a connector provided in said housing for providing controlled access to said updateable web server by an authorised content provider to facilitate updating of said updateable web server with information;
wherein the wi-fi transmitter is accessible by one or more electronic devices associated with the localised audience such that the information contained in the web server can be reviewed by a conventional web browser of the electronic device in the absence of a remote network connection.

2. A system according to claim 1, wherein the base unit further comprises a power source for providing power to said computer system of the base unit.

3. A system according to claim 2, wherein the power source is a battery chargeable by a solar panel mounted with respect to the base unit.

4. A system according to claim 1, wherein the connector is a USB port and the access to the updateable web server is controlled by a computer controller of the computer system, said computer controller only facilitating access to said updateable web server by a paired USB stick provided by an authorised content provider.

5. A system according to claim 4, wherein upon the computer controller acknowledging that the USB stick is paired with the computer controller, the information contained on said USB stick automatically updates the updateable web server.

6. A system according to any one of the preceding claims, wherein the one or more electronic devices comprises a personal electronic device

7. A system according to any one of the preceding claims, wherein the personal electronic device is a smart phone or tablet.

8. A method of providing off-network electronic communication to a localised audience comprising:
constructing a base unit for access by the localised audience;
activating the base unit to be accessible to the localized audience;
facilitating information exchange between the base unit and the localized audience; and
controlling the update of information contained by the base unit to maintain currency and integrity of the information.

9. A method according to claim 8, wherein the step of constructing the base unit comprises forming a site for the base unit to be constructed, the site comprising a foundation for supporting the base unit thereon.

10. A method according to claim 9, wherein the base unit comprises a housing for housing a server having one or more microprocessors and memory operably connected to one or more central processing units, and the housing is mounted upon the foundation.

11. A method according to claim 10, wherein the step of activating the base unit to be accessible to the localized audience comprises connecting the base unit to one or more solar panels for supplying power to the server.

12. A method according to any one of claims 8-11, wherein the step of facilitating information exchange between the base unit and the localized audience comprises enabling localised individuals to access the base unit via their existing web browser.

13. A method according to claim 12, wherein the localised audience are enabled to browse and/or download a variety of information such as maps, photos, videos, pdf files, text files and the like using their existing web browser on their smart phone or tablet.
